(19) United States
(12) Patent Application Publication
(10) Pub. No.: US 2026/0365821 A1
(43) Pub. Date: Nov. 19, 2026

(54) SIMPLIFIED PREPARATION PROCESS OF GRAPHENE OXIDE-MODIFIED NATURAL RUBBER WITH HIGH TEAR STRENGTH BASED ON INTERPENETRATING DOUBLE CROSSLINKED NETWORK STRUCTURE CONSTRUCTED BY DUAL VULCANIZING AGENTS

(71) Applicant: North University of China, Taiyuan (CN)

(72) Inventors: Yaqing Liu, Taiyuan (CN); Shuaishuai Cheng, Taiyuan (CN); Guizhe Zhao, Taiyuan, Shanxi (CN); Huatao Cheng, Taiyuan (CN); Haoyu Duan, Taiyuan (CN)

(21) Appl. No.: 19/292,427

(22) Filed: Aug. 6, 2025

(30) Foreign Application Priority Data
May 19, 2025 (CN) 202510642036.8

(51) Int. Cl. C08K 3/04; C08C 1/02; C08J 3/26

(52) U.S. Cl. CPC C08K 3/042; C08C 1/02; C08J 3/26

(57) ABSTRACT

The present disclosure provides a simplified preparation process of a graphene oxide-modified natural rubber (GO/NR) with high tear strength based on interpenetrating double crosslinked network structure constructed by dual vulcanizing agents. Two vulcanizing agents, sulfur and peroxide are adopted in the present disclosure. The sulfur rapidly forms a carbon-sulfur bond crosslinked network —C-Sx-C— with high cross-linking density, a mechanical load-bearing skeleton is constituted between main chains of NR and —C-Sx-C— is endowed with high tear strength and fatigue resistance; and the peroxide constructs a stable secondary crosslinked network of C—C— crosslinking bonds, improving the three-dimensional structural integrity of a vulcanization network, reducing the loss modulus of rubber, and reducing the heat generation during the dynamic compression of rubber. In the present disclosure, the tearing strength of NR vulcanizate is effectively improved based on the synergy of nanofiller reinforcement and interpenetrating double crosslinked network structure.

### CROSS-REFERENCE TO RELATED APPLICATION

This application claims priority of Chinese Patent Application No. 202510642036.8, filed on May 19, 2025, the entire contents of which are incorporated herein by reference.

### TECHNICAL FIELD

The present disclosure relates to the technical field of graphene and functional rubber composite materials, and in particular to a simplified preparation process of a graphene oxide-modified natural rubber (GO/NR) with high tear strength based on interpenetrating double crosslinked network structure constructed by dual vulcanizing agents.

### BACKGROUND

As a strategic polymer material, NR plays a leading role in tire tread, industrial conveyor belt and heavy equipment seals due to its high elasticity, high wear resistance and dynamic fatigue performance. However, with the development of extreme and lightweight modern equipment, the tear strength of traditional NR composite materials is gradually difficult to meet the requirements. For example, under high-speed dynamic loading of tires, the proportion of tear failures caused by tread cracks propagating along the stress concentration zone exceeds 60%; and the longitudinal tear of conveyor belt in mine directly leads to shutdown accidents, resulting in significant economic losses. The core of these problems is that the tear strength of NR matrix itself is limited, and the single crosslinked network formed by traditional vulcanization is easy to induce micro-crack proliferation due to local stress concentration, which eventually leads to macro-tear.

Nowadays, improving the tear strength of rubber mainly starts from preventing crack propagation and reducing crack source. Nanofiller reinforcement strategy is commonly used to prevent crack propagation. Nanofillers (including GO, carbon nanotubes (CNT), etc.) have large specific surface area and abundant surface active groups. Rubber molecular chains can be adsorbed on the surface of fillers by van der Waals forces, hydrogen bonds and other physical effects when the rubber molecular chains contact with nanofillers. This adsorption makes the rubber molecular chains form a certain restraint on the filler surface, forming an entangled structure, and hindering the crack propagation path, thereby preventing the crack propagation. However, the following bottlenecks exist in practical applications; 1, the filler disperses unevenly and becomes crack source; and 2, the crosslink density and distribution range of a single vulcanization system are limited, and it is difficult to construct a multi-level energy dissipation mechanism to resist tear propagation.

Interpenetrating double crosslinked network is a design strategy for polymer materials. The core feature of interpenetrating double crosslinked network is that two or more polymer networks penetrate each other and form synergistic effects through multiple crosslinked mechanisms. Interpenetrating property means that two or more independently crosslinked polymer networks intertwine with each other at molecular scale to form a three-dimensional interpenetrating topological structure. Double crosslinked mode combines physical crosslinked (such as hydrogen bond, van der Waals force and crystalline domain) and chemical crosslinked (covalent bond and dynamic bond) within the network or the combination of different chemical crosslinked systems. Performance advantages mainly include the following: (1) mechanical performance: high strength and toughness are achieved through energy dissipation mechanisms (including dynamic bond breakage and reorganization) and network synergy; and (2) functional adjustability: by adjusting the crosslink density, network ratio and crosslinked type, the materials can be made self-healing, recyclable or environmentally responsive.

Cooperation of different crosslinked networks to reduce crack source has become an important method to improve tear strength of rubber composite materials. That is, the different crosslinked reaction rates of two or more vulcanizing agents can be used to preferentially form a crosslinked network in NR composite materials, and serve as a mechanical load-bearing skeleton between NR main chains. Subsequently, the crosslinked network of another vulcanizing agent builds a secondary crosslinked network in addition to the previous crosslinked network already formed, filling the defects of the previous crosslinked network, including main chain unreacted sites, and forming more crosslinked points at branched chains. Finally, by improving the uniformity of the crosslinked network, the crack source and its propagation are reduced, and a multi-level tear-resistant barrier is formed, thereby effectively improving the tear strength of rubber composite materials and prolonging the service life.

NR typically requires vulcanization during processing to improve stability and durability. Peroxide vulcanization is a commonly used vulcanization method. The principle is to add peroxide as a vulcanizing agent to rubber. After heating, the peroxide releases active oxygen to promote the formation of stable carbon-carbon bond crosslinked network between rubber molecular chains, thereby achieving the objective of vulcanization. Advantages of peroxide vulcanizates include: 1, excellent high temperature resistance and good thermal stability; 2, small compression set and low creep; and 3, anti-reversion outstanding and suitable for long-time vulcanization process. Disadvantages include the following: 1, mechanical strength (e.g. tear resistance) is generally lower than sulfur vulcanizing systems; and 2, processing safety is poor and strict temperature control is required to prevent early decomposition. Therefore, although peroxide plays a certain role in the vulcanization process of NR, due to its slow reaction speed and not widely used, traditional vulcanizing agents, including sulfur or thioethers, are still used in practical applications.

### SUMMARY

In the present disclosure, in order to enhance the tear strength of NR vulcanizate, based on the efficient synergy of nanofiller reinforcement and interpenetrating double crosslinked network structure, the tear strength of NR vulcanizate is improved simultaneously from two aspects: preventing crack propagation and reducing the generation of crack sources. This breaks through the physical limit of traditional reinforcement strategies and can provide a brand-new solution path for the next generation of high-tear-strength rubber composite materials.

The present disclosure is realized by the following technical solutions. A simplified preparation process of GO/NR with high tear strength based on interpenetrating double crosslinked network structure constructed by dual vulcanizing agents includes the following steps:
step 1, adding a certain amount of deionized water to NR latex at a temperature T₁, adding a certain amount of graphene oxide aqueous dispersion, mechanically stirring a mixture at a stirring speed v₁ for a time t₁, adding a flocculant to flocculate the latex, washing and dewatering the obtained raw rubber for many times, and drying the treated raw rubber to a constant weight at a temperature of T₂ to obtain a GO/NR masterbatch;
step 2, placing the GO/NR masterbatch obtained in step 1 in an internal mixer, mixing the GO/NR masterbatch at a temperature T₃ for a time t₂, discharging a rubber compound, and adding a rubber assistant and a reinforcing filler during this period; and cooling the discharged rubber compound to room temperature, using an open mill to open mill at a temperature T₄ for a time t₃, adding vulcanizing agents sulfur and peroxide in sequence during this period, after uniform mixing, reducing a roller distance to reduce the thickness until the rubber compound is free of bubbles, and obtaining a mixed rubber; and
step 3, placing the mixed rubber at a temperature t₅ for a time t₄, and vulcanizing the mixed rubber in a mold at a temperature T₆ and a certain pressure P₁ for a time t₅, in which in a vulcanization process, the vulcanizing agent sulfur rapidly forms a carbon-sulfur bond crosslinked network —C-Sx-C— with high crosslink density in NR composite materials, a mechanical load-bearing skeleton is constituted between main chains of NR and —C-Sx-C— is endowed with high tear strength and fatigue resistance; a vulcanization rate of the peroxide is relatively slow, the peroxide slowly decomposes in a lower temperature region to generate free radicals, and a stable secondary crosslinked network of C—C— crosslinking bonds between terminal segments of a carbon-sulfur bond main network is constructed outside a sulfur vulcanization skeleton network, improving the three-dimensional structural integrity of a vulcanization network, reducing the loss modulus of rubber, and reducing the heat generation during the dynamic compression of rubber; and a GO/NR with high tear strength based on interpenetrating double crosslinked network structure constructed by dual vulcanizing agents is obtained.

In a further improvement of the technical solutions of the present disclosure, the peroxide is selected from at least one of benzoyl peroxide, di-tert-butyl peroxide, tert-butyl perbenzoate, and dicumyl peroxide.

In a further improvement of the technical solutions of the present disclosure, in step 1, the temperature T₁ is room temperature; the addition amount of the deionized water is that a concentration of the prepared natural latex emulsion is 15-35 wt %; the stirring time t₁ is 10-60 min and the stirring speed v₁ is 100-1000 rad/min; and the oven drying temperature T₂ of the raw rubber is 40-800 °C.

In a further improvement of the technical solutions of the present disclosure, in step 1, a concentration of the added graphene oxide dispersion is 1-10 mg/mL; the flocculant is selected from at least one of calcium chloride, formic acid, hydrochloric acid, sodium chloride and potassium chloride solution, and has a concentration of 5-20 wt %; and a mass ratio of NR to graphene oxide in the obtained GO/NR masterbatch is 100:0.2-2.

In a further improvement of the technical solutions of the present disclosure, in step 2, the internal mixing temperature T₃=100-120 °C, and the internal mixing time t₂=10-16 min; and the open milling temperature T₄=50-70 °C, and the open milling time t₃=10-15 min.

In a further improvement of the technical solutions of the present disclosure, in step 2, the rubber assistant includes antioxidant, antioxidant, vulcanization accelerator, activator and softener according to a mass ratio of 2:2:2:5:2; and a mass ratio of the NR to the reinforcing filler in the GO/NR masterbatch is 100:35.

In a further improvement of the technical solutions of the present disclosure, the vulcanization accelerator is at least one of N-tert-butyl-2-benzothiazole sulfenamide, N-cyclohexyl-2-benzothiazole sulfenamide and N-(ethylene oxide)-2-benzothiazole sulfenamide; the antioxidant is at least one of 2,6-di-tert-butyl-4-methylphenol, 2,2,4-trimethyl-1,2-dihydroquinoline polymer and 2-thiobenzimidazole; the antioxidant is at least one of N-(1-methylisoamyl)-N′-phenyl-p-phenylenediamine and p-phenylaniline or dilauryl sulfide dipropionate; the activator is at least one of zinc gluconate, zinc oxide and magnesium oxide; the softener is at least one of stearic acid, dibutyl titanate and dioctyl adipate; and the reinforcing filler is at least one of carbon black N110, N220, N330, N339, N375, N550, N660 and silica.

In a further improvement of the technical solutions of the present disclosure, in step 2, a mass ratio of the NR to the rubber assistant in the GO/NR masterbatch is 100:8-15; and a mass ratio of the NR, sulfur and peroxide in the GO/NR masterbatch is 100:0.5-4:0.5-4.

In a further improvement of the technical solutions of the present disclosure, in step 3, T₅=room temperature, the time for placing the mixed rubber t₄=20-30 h; and the vulcanization temperature T₆=140-160 °C, the vulcanization pressure P₁=10-20 MPa, and the vulcanization time t₅=5-15 min.

Compared with the related art, the present disclosure has the following beneficial effects.
1. In the present disclosure, an entangled structure is formed by the adsorption effect between the functional groups on the surface of the graphene oxide nanofiller and the rubber molecular chain, thereby preventing the crack propagation path and improving the tear strength.
2. In the present disclosure, the interpenetrating double crosslinked network structure is formed by two vulcanizing agents: the vulcanization rate of sulfur is relatively fast, and a carbon-sulfur bond crosslinked network —C-Sx-C— with high crosslink density is preferentially formed in the NR composite materials to constitut a mechanical load-bearing skeleton between the main chains of NR, and endowing —C-Sx-C— with high tear strength and fatigue resistance. A vulcanization rate of the peroxide is relatively slow, the peroxide slowly decomposes in a lower temperature region to generate free radicals, and a stable secondary crosslinked network of C—C— crosslinking bonds between the terminal segments of a carbon-sulfur bond main network is constructed outside the sulfur vulcanization skeleton network, improving the three-dimensional structural integrity of a vulcanization network, reducing the loss modulus of rubber, and reducing the heat generation during the dynamic compression of rubber.
3. In the present disclosure, through the efficient synergy of nanofiller reinforcement and interpenetrating double crosslinked network structure, the tear strength of NR vulcanizate is improved simultaneously from two aspects: preventing crack propagation and reducing the generation of crack sources. This breaks through the physical limit of traditional reinforcement strategies and can provide a brand-new solution path for the next generation of high-tear-strength rubber composite materials.
4. In the present disclosure, the preparation process is simple without severe requirements, and all involved are conventional apparatuses, which is easy for industrial production.

### BRIEF DESCRIPTION OF THE DRAWINGS

The accompanying drawings, which are incorporated in and constitute a part of this specification, illustrate examples consistent with the present disclosure and together with the description, and serve to explain the principles of the present disclosure.

To explain the technical solutions of examples in the present disclosure or in the prior art more clearly, the accompanying drawings required in the description of the examples or the prior art are introduced briefly below. Obviously, other drawings can be obtained according to these drawings without creative efforts for those ordinary skilled in the art.

FIG. 1 is a Fourier transform infrared (FT-IR) spectrum of a GO/NR prepared in Examples 1-5 and Comparative Examples 1-3 of the present disclosure.

FIG. 2 is a graph showing vulcanization curves of the GO/NR prepared in Examples 1-5 and Comparative Examples 1-3 of the present disclosure.

FIG. 3A is a schematic diagram of mechanical behaviors of the GO/NR under tearing action prepared in Comparative Examples 1-3 of the present disclosure.

FIG. 3B is a schematic diagram of mechanical behaviors of the GO/NR under tearing action prepared in Examples 1-5 of the present disclosure.

### DETAILED DESCRIPTION

To understand the above objects, features and advantages of the present disclosure more clearly, the solutions of the present disclosure will be further described below. It is to be noted that the examples of the present disclosure and the features in the examples can be combined with each other without conflict.

In the following description, many specific details are set forth to provide a thorough understanding of the present disclosure, but the present disclosure can also be implemented in other ways than those described here. Obviously, the examples in the specification are only some examples of the present disclosure, but not all examples.

An example of the present disclosure provides a simplified preparation process of a GO/NR with high tear strength based on interpenetrating double crosslinked network structure constructed by dual vulcanizing agents, including the following steps.

In step 1, a certain amount of deionized water is added to NR latex at a temperature T₁, a certain amount of GO aqueous dispersion is added, the mixture is mechanically stirred at a stirring speed v₁ for a time t₁, and added with a flocculant to flocculate the latex; and the treated raw rubber is washed and dewatered for many times, and dried to a constant weight at a temperature of T₂ to obtain a GO/NR masterbatch.

In step 2, the GO/NR masterbatch obtained in step 1 is placed in an internal mixer, mixed at a temperature T₃ for a time t₂, the GO/NR masterbatch is discharged, and a rubber assistant and a reinforcing filler are added during this period; and the discharged rubber compound is cooled to room temperature, an open mill is used to open mill at a temperature T₄ for a time t₃, vulcanizing agents sulfur and peroxide are added in sequence during this period, after uniform mixing, a roller distance is reduced to reduce the thickness until the rubber compound is free of bubbles, and a mixed rubber is obtained.

In step 3, the mixed rubber is placed at a temperature t₅ for a time t₄, and vulcanized in a mold at a temperature T₆ and a certain pressure P₁ for a time t₅; in a vulcanization process, the vulcanizing agent sulfur rapidly forms a carbon-sulfur bond crosslinked network —C-Sx-C— with high crosslink density in NR composite materials, a mechanical load-bearing skeleton is constituted between main chains of NR and —C-Sx-C— is endowed with high tear strength and fatigue resistance; a vulcanization rate of the peroxide is relatively slow, the peroxide slowly decomposes in a lower temperature region to generate free radicals, and a stable secondary crosslinked network of C—C— crosslinking bonds between terminal segments of a carbon-sulfur bond main network is constructed outside a sulfur vulcanization skeleton network, improving the three-dimensional structural integrity of a vulcanization network, reducing the loss modulus of rubber, and reducing the heat generation during the dynamic compression of rubber; and a GO/NR with high tear strength based on interpenetrating double crosslinked network structure constructed by dual vulcanizing agents is obtained.

In an instance provided by the present disclosure, the peroxide is selected from at least one of benzoyl peroxide, di-tert-butyl peroxide, tert-butyl perbenzoate, and dicumyl peroxide.

In another instance provided by the present disclosure, in step 1, the temperature T₁ is room temperature; the addition amount of the deionized water is that a concentration of the prepared natural latex emulsion is 15-35 wt %; the stirring time t₁ is 10-60 min and the stirring speed v₁ is 100-1000 rad/min; and the oven drying temperature T₂ of the raw rubber is 40-800 °C.

In an instance provided by the present disclosure, in step 1, a concentration of the added graphene oxide dispersion is 1-10 mg/mL; the flocculant is selected from at least one of calcium chloride, formic acid, hydrochloric acid, sodium chloride and potassium chloride solution, and has a concentration of 5-20 wt %; and a mass ratio of NR to graphene oxide in the obtained GO/NR masterbatch is 100:0.2-2.

In another instance provided by the present disclosure, in step 2, the internal mixing temperature T₃=100-120 °C, and the internal mixing time t₂=10-16 min; and the open milling temperature T₄=50-70 °C, and the open milling time t₃=10-15 min.

In an instance provided by the present disclosure, in step 2, the rubber assistant includes antioxidant, antioxidant, vulcanization accelerator, activator and softener according to a mass ratio of 2:2:2:5:2; and a mass ratio of the NR to the reinforcing filler in the GO/NR masterbatch is 100:35.

In another instance provided by the present disclosure, the vulcanization accelerator is at least one of N-tert-butyl-2-benzothiazole sulfenamide, N-cyclohexyl-2-benzothiazole sulfenamide and N-(ethylene oxide)-2-benzothiazole sulfenamide; the antioxidant is at least one of 2,6-di-tert-butyl-4-methylphenol, 2,2,4-trimethyl-1,2-dihydroquinoline polymer and 2-thiobenzimidazole; the antioxidant is at least one of N-(1-methylisoamyl)-N′-phenyl-p-phenylenediamine and p-phenylaniline or dilauryl sulfide dipropionate; the activator is at least one of zinc gluconate, zinc oxide and magnesium oxide; the softener is at least one of stearic acid, dibutyl titanate and dioctyl adipate; and the reinforcing filler is at least one of carbon black N110, N220, N330, N339, N375, N550, N660 and silica.

In an instance provided by the present disclosure, in step 2, a mass ratio of the NR to the rubber assistant in the GO/NR masterbatch is 100:8-15; and a mass ratio of the NR, sulfur and peroxide in the GO/NR masterbatch is 100:0.5-4:0.5-4.

In another instance provided by the present disclosure, in step 3, T₅=room temperature, the time for placing the mixed rubber t₄=20-30 h; and the vulcanization temperature T₆=140-160 °C, the vulcanization pressure P₁=10-20 MPa, and the vulcanization time t₅=5-15 min.

The technical solutions of the present disclosure will be described in detail below through specific examples.

### Example 1

A simplified preparation process of a GO/NR with high tear strength based on interpenetrating double crosslinked network structure constructed by dual vulcanizing agents specifically includes the following steps that.

In step 1, deionized water was added into NR latex emulsion at room temperature (25 °C) to control a concentration to 30 wt %; 2.5 mg/mL GO aqueous dispersion was added and stirred mechanically for 30 min at 500 rad/min; a 10 wt % calcium chloride solution was added to flocculate the latex, and a volume ratio of natural latex emulsion: GO aqueous dispersion: calcium chloride solution was 167:100:30; and after repeated washing and dewatering, the obtained raw rubber was dried at 60 °C to constant weight, and a modified NR master rubber with a mass ratio of NR to graphene oxide of 100:0.5 was obtained, that is, GO/NR master rubber.

In step 2, the GO/NR masterbatch prepared in step 1 having an NR content of 100 phr was added into an internal mixer at 110 °C for 4 min, and 2 phr of an antioxidant N-(1, 3-dimethylbutyl)-N′-phenyl-p-phenylenediamine (4020), 2 phr of an antioxidant 2,2,4-trimethyl-1,2-dihydroquinoline polymer (RD) and 2 phr of a vulcanization accelerator N-cyclohexyl-2-benzothiazole sulfenamide (CZ) were added; after mixing for 4 min, 5 phr of an activator zinc oxide and 2 phr softener stearic acid were added and mixed for 4 min, 35 phr of N330 carbon black was added, and a rubber compound was discharged; and the discharged rubber compound was cooled to room temperature and mixed in an open mill at 60 °C for 10 min, during this period, 1.5 phr of sulfur and 1 phr of benzoyl peroxide (BPO) were added in sequence, and after uniform mixing, the mixture was thinly passed until the rubber compound was free of bubbles to obtain a mixed rubber.

In step 3, the rubber mixture was placed in a mold after 24 h at room temperature, and vulcanized at 15 MPa and 150 °C for 6 min according to t_{c90} (t_{c90} is determined by rubber processing analyzer). In a vulcanization process, the vulcanizing agent sulfur rapidly formed a carbon-sulfur bond crosslinked network —C-Sx-C— with high crosslink density in NR composite materials, which constituted a mechanical load-bearing skeleton between main chains of the NR and endowed high tear strength and fatigue resistance; a vulcanization rate of the peroxide was relatively slow, the peroxide slowly decomposed in a lower temperature region to generate free radicals, a stable secondary crosslinked network of C—C— crosslinking bonds between terminal segments of a carbon-sulfur bond main network was constructed outside the sulfur vulcanization skeleton network, the three-dimensional structural integrity of a vulcanization network was improved, the loss modulus of rubber was reduced, and the heat generation during dynamic compression of rubber was further reduced; and a GO/NR with high tear strength based on interpenetrating double crosslinked network structure constructed by dual vulcanizing agents was obtained.

### Example 2

Same as Example 1, except that BPO was added in an amount of 2 phr.

### Example 3

Same as Example 1, except that BPO was added in an amount of 3 phr.

### Example 4

Same as Example 1, except that sulfur was added in an amount of 1 phr.

### Example 5

Same as Example 1, except that the sulfur was added in an amount of 2 phr.

### Comparative Example 1

A simplified preparation process of a GO/NR based on a single vulcanizing agent had the same specific steps as in Example 1, except that BPO was not added and sulfur was added in an amount of 1 phr.

### Comparative Example 2

Same as Example 1, except that BPO was not added and sulfur was added in an amount of 1.5 phr.

### Comparative Example 3

Same as Example 1, except that BPO was not added and sulfur was added in an amount of 2 phr.

Performance tests were performed on the GO/NR composite materials obtained in Examples 1-5 and Comparative Examples 1-3. A test standard for tensile performance is GB/T 528-2009, and a tensile rate is 500 mm/min. A test standard for tear performance is GB/T 529-2008. A test standard for hardness is GB/T531.1-2008. A test standard for crosslink density is GB/T 533-2008. A test standard for thermal performance is GB/T1687.1-2016.

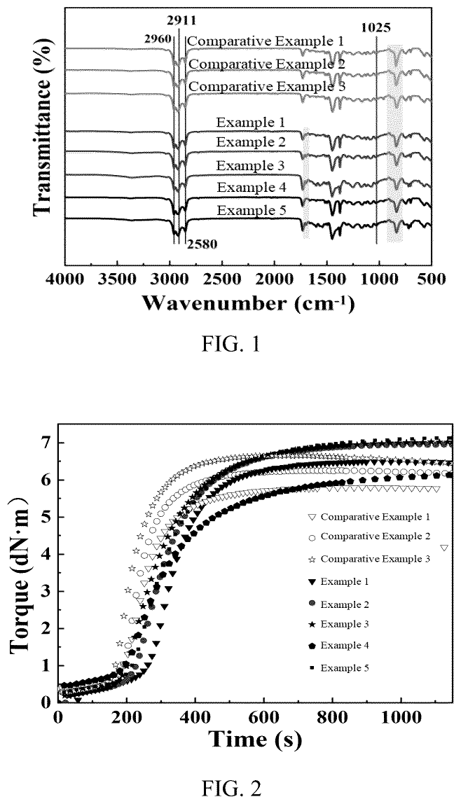

It can be seen from FIG. 1, for the GO/NR composite materials with interpenetrating double crosslinked network structure prepared in Examples 1-5, a characteristic absorption peak at 836-838 cm-1 corresponds to the out-of-plane bending vibration of the —C═C— bond in the cis-1,4-isoprene structure, and an intensity of this peak can be used as an important indicator of the degree of double bond reaction. For a single sulfur crosslinked system GO/NR of Comparative Examples 1-3, the crosslinked reaction mainly involves the —C═C-double bonds in the isoprene units. From FT-IR spectra, it is observed that the intensity of the characteristic —C═C— peak at 836 cm⁻¹ exhibits a gradient-like decay as the sulfur addition increased from 1 phr to 2 phr, indicating that the sulfur radicals preferentially attack the double bond structure, thereby preferentially forming a crosslinked network of sulfur bonds (—C-Sx-C—). Further, for Examples 1-5, the peak intensity at 836 cm⁻¹ remains stable after the addition of BPO as a crosslinked agent, indicating that the reaction of BPO to the double bonds is relatively limited. Benzoic acid will be generated after BPO participates in the vulcanization reaction, and a characteristic C═O peak of benzoic acid is detected at 1699 cm⁻¹, which further proves that BPO can participate in the crosslinked reaction. Therefore, by adding sulfur and BPO (S/BPO) at the same time, GO/NR composite materials with interpenetrating double crosslinked network structure can be obtained.

It can be seen from FIG. 2 that compared with Comparative Examples 1-3, the crosslink density of the rubber composite materials prepared in Examples 1-5 of the present disclosure has increased, but the increase is not large, indicating that the C—C bonds formed by BPO crosslinked are mainly supplemented with carbon-sulfur crosslinked networks. In addition, compared with Comparative Examples 1-3, vulcanization curves of Examples 1-5 have a slower rate during the rapid vulcanization period. It can be seen that the crosslink rate of BPO is slower and mainly plays a complementary role on the carbon-sulfur crosslinked network.

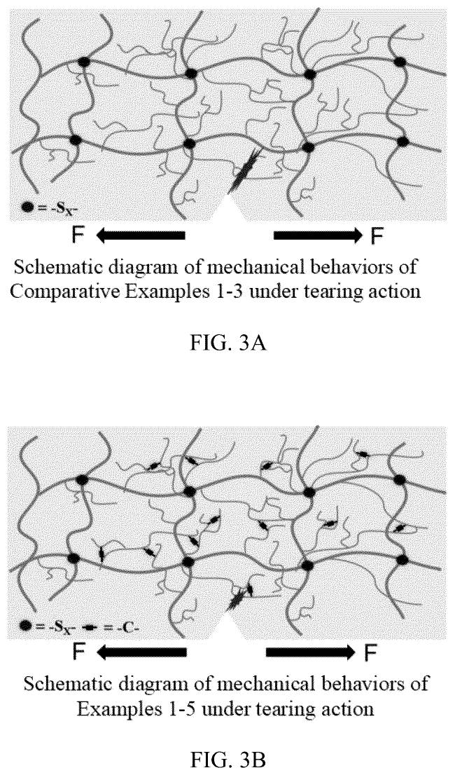

FIG. 3A and FIG. 3B are schematic diagrams of the mechanical behavior of GO/NR composite materials under tearing action prepared in Examples 1-5 and Comparative Examples 1-3. These figures are drawn on the basis of reasonable speculation on the improvement in tear performance to further clarify the mechanism by which the interpenetrating double-crosslinked network structure improves tear performance.

According to the above test and analysis results (FIGS. 1-3B), it can be seen that from the perspective of vulcanization mechanism, for the GO/NR composite materials prepared by S/BPO dual crosslinked agent, BPO can be decompose to generate free radicals to further initiate the crosslinked reaction of rubber molecular chains and improve the uniformity of the crosslink density and rubber network. At the same time, the —C═C— crosslinked bond initiated by BPO and the —C-Sx-C— crosslinked formed by sulfur synergize efficiently to optimize the interaction between rubber molecular chains, and the material can more effectively transmit stress during stretching and tearing, thereby significantly improving the tear strength of the materials, indicating that the dual crosslinked system of the present disclosure has significant advantages in improving the tear resistance of NR, and can effectively inhibit crack propagation and improve the toughness of the rubber. In addition, it is further proved that, in the present disclosure, based on the efficient synergy of nanofiller reinforcement and interpenetrating double-crosslinked network structure, the objective of significantly improving the tear strength of NR vulcanizate from two aspects of preventing crack propagation and reducing crack source generation is indeed achieved.

TABLE 1
Formulation table of Comparative Examples 1-3 and Examples 1-5

| | Comparison | Comparative | Comparative | Example | Example | Example | Example | Example |
|---|---|---|---|---|---|---|---|---|
| Samples | Example 1 | Example 2 | Example 3 | 1 | 2 | 3 | 4 | 5 |
| NR (phr) | 100 | 100 | 100 | 100 | 100 | 100 | 100 | 100 |
| 4020 (phr) | 2 | 2 | 2 | 2 | 2 | 2 | 2 | 2 |
| RD (phr) | 2 | 2 | 2 | 2 | 2 | 2 | 2 | 2 |
| Zinc oxide | 5 | 5 | 5 | 5 | 5 | 5 | 5 | 5 |
| (phr) | | | | | | | | |
| Stearic | 2 | 2 | 2 | 2 | 2 | 2 | 2 | 2 |
| acid (phr) | | | | | | | | |
| CZ (phr) | 2 | 2 | 2 | 2 | 2 | 2 | 2 | 2 |
| GO (phr) | 0.5 | 0.5 | 0.5 | 0.5 | 0.5 | 0.5 | 0.5 | 0.5 |
| Sulfur | 1 | 1.5 | 2 | 1.5 | 1.5 | 1.5 | 1 | 2 |
| (phr) | | | | | | | | |
| BPO (phr) | 0 | 0 | 0 | 1 | 2 | 3 | 1 | 1 |

TABLE 2
Performance of Comparative Examples 1-3 and Examples 1-5

| | Comparative | Comparative | Comparative | Example | Example | Example | Example | Example |
|---|---|---|---|---|---|---|---|---|
| Samples | Example 1 | Example 2 | 3 | 1 | 2 | 3 | 4 | 5 |
| Tensile | 27.1 | 27.5 | 28.2 | 27.3 | 28.8 | 27.2 | 27.1 | 28.3 |
| strength | | | | | | | | |
| (MPa) | | | | | | | | |
| Tear | 53.1 | 55.7 | 58.9 | 61.7 | 91.1 | 88.5 | 59.4 | 62.3 |
| strength | | | | | | | | |
| (N/mm) | | | | | | | | |
| Crosslink | 5.7 | 6.6 | 7.1 | 5.2 | 3.3 | 2.5 | 3.6 | 6.8 |
| rate | | | | | | | | |
| (*10-3/s) | | | | | | | | |
| Crosslink | 2.15 | 2.22 | 2.40 | 2.37 | 2.42 | 2.49 | 2.20 | 2.46 |
| density | | | | | | | | |
| (*10-4 | | | | | | | | |
| mol/cm3) | | | | | | | | |
| Heat | 15.4 | 14.7 | 14.0 | 14.2 | 13.5 | 13.2 | 14.1 | 13.4 |
| generation | | | | | | | | |
| value under | | | | | | | | |
| compression | | | | | | | | |
| Fatigue(°C) | | | | | | | | |
| Hardness | 58.5 | 59.0 | 60.0 | 59.0 | 61.0 | 61.5 | 59.0 | 61.0 |
| (HA) | | | | | | | | |

It can be seen from Table 2 that the tensile strength, tear strength, hardness, dynamic compression fatigue heat generation performance and crosslink density of the GO/NR with high tear strength based on the interpenetrating double crosslinked network structure constructed by dual vulcanizing agents of the present disclosure (Examples 1-5) are improved compared with the GO/NR composite materials with single sulfur vulcanization system in Comparative Examples 1-3. In particular, for Comparative Example 2, the tear strength of Example 2 is improved by 63.5%, and the improvement effect is significant. In addition, compared to Comparative Examples 1-3, the crosslink rate of Examples 1-5 is reduced, again indicating: the sulfur in the dual vulcanizing agent has a fast vulcanization rate and is preferred to rapidly form a carbon-sulfur bond crosslinked network with a high crosslink density —C-Sx-C— in NR composite materials. The vulcanization rate of BPO is slow, which selectively fills the defects of sulfur vulcanization network (including unreacted sites in the main chain) and forms stable —C═C— crosslinked bonds at the branch chains, thereby improving the structural integrity of the crosslinked network. In addition, compared with the GO/NR vulcanized with a single sulfur in Comparative Example 2, the crosslinked densities of GO/NR with interpenetrating double crosslinked network structures in Examples 1-3 with the same sulfur addition amount have increased by 6.8%, 9.0% and 12.2%, the tear strengths have increased by 10.8%, 63.6% and 58.9%, the heat generation performance of compression fatigue has decreased by 3.4%, 8.2% and 10.2%, and the hardness has increased by 0, 3.4% and 4.2%. It is further proved that, in the present disclosure, based on the efficient synergy of nanofiller reinforcement and interpenetrating double-crosslinked network structure, the objective of significantly improving the tear strength of NR vulcanizate from two aspects of preventing crack propagation and reducing crack source generation is indeed achieved. In addition, the heat generation value of rubber during dynamic compression is also reduced.

The above descriptions are only specific embodiments of the present disclosure, and those skilled in the art can understand or implement the present disclosure. Although the present disclosure has been described in detail with reference to the foregoing examples, those ordinary skilled in the art will understand that the technical solutions disclosed in the above examples can still be modified, or some of the technical features can be replaced by equivalents. These modifications and substitutions do not make the essence of the corresponding technical solutions depart from the scope of the technical solutions of various examples, and are to be covered by the protection scope of the claims.

1. A preparation process of a graphene oxide-modified natural rubber (GO/NR) based on interpenetrating double crosslinked network structure constructed by dual vulcanizing agents, comprising the following steps:
step 1, adding a certain amount of deionized water to NR latex at a temperature T₁, adding a certain amount of GO aqueous dispersion, mechanically stirring a mixture at a stirring speed v₁ for a time t₁, adding a flocculant to flocculate the latex, washing and dewatering the obtained raw rubber for many times, and drying the treated raw rubber to a constant weight at a temperature of T₂ to obtain a GO/NR masterbatch;
step 2, placing the GO/NR masterbatch obtained in step 1 in an internal mixer, mixing the GO/NR masterbatch at a temperature T₃ for a time t₂, discharging a rubber compound, and adding a rubber assistant and a reinforcing filler during this period; and cooling the discharged rubber compound to room temperature, using an open mill to open mill at a temperature T₄ for a time t₃, adding vulcanizing agents sulfur and peroxide in sequence during this period, after uniform mixing, reducing a roller distance to reduce the thickness until the rubber compound is free of bubbles, and obtaining a mixed rubber; wherein the peroxide is benzoyl peroxide, and a mass ratio of the NR to the sulfur to the peroxide in the GO/NR masterbatch is 100:1.5:2-3; and
step 3, placing the mixed rubber at a temperature t₅ for a time t₄, and vulcanizing the mixed rubber in a mold at a temperature T₆ and a certain pressure P₁ for a time t₅, to obtain a GO/NR based on interpenetrating double crosslinked network structure constructed by dual vulcanizing agents.

2. (canceled)

3. The preparation process of a GO/NR based on interpenetrating double crosslinked network structure constructed by dual vulcanizing agents according to claim 1, wherein in step 1, the temperature T₁ is room temperature; the addition amount of the deionized water is that a concentration of the prepared natural latex emulsion is 15-35 wt %; the stirring time t₁ is 10-60 min and the stirring speed v₁ is 100-1000 rad/min; and an oven drying temperature T₂ of the raw rubber is 40-80 °C.

4. The preparation process of a GO/NR based on interpenetrating double crosslinked network structure constructed by dual vulcanizing agents according to claim 1, wherein in step 1, a concentration of the added graphene oxide dispersion is 1-10 mg/mL; the flocculant is selected from at least one of calcium chloride, formic acid, hydrochloric acid, sodium chloride and potassium chloride solution, and has a concentration of 5-20 wt %; and a mass ratio of NR to graphene oxide in the obtained GO/NR masterbatch is 100:0.2-2.

5. The preparation process of a GO/NR based on interpenetrating double crosslinked network structure constructed by dual vulcanizing agents according to claim 1, wherein in step 2, the internal mixing temperature T₃=100-120 °C, and the internal mixing time t₂=10-16 min; and the open milling temperature T₄=50-70 °C, and the open milling time t₃=10-15 min.

6. The preparation process of a GO/NR based on interpenetrating double crosslinked network structure constructed by dual vulcanizing agents according to claim 1, wherein in step 2, the rubber assistant comprises antioxidant, antioxidant, vulcanization accelerator, activator and softener according to a mass ratio of 2:2:2:5:2; and a mass ratio of the NR to the reinforcing filler in the GO/NR masterbatch is 100:35.

7. The preparation process of a GO/NR based on interpenetrating double crosslinked network structure constructed by dual vulcanizing agents according to claim 6, wherein the vulcanization accelerator is at least one of N-tert-butyl-2-benzothiazole sulfenamide, N-cyclohexyl-2-benzothiazole sulfenamide and N-(ethylene oxide)-2-benzothiazole sulfenamide; the antioxidant is at least one of 2,6-di-tert-butyl-4-methylphenol, 2,2,4-trimethyl-1,2-dihydroquinoline polymer and 2-thiobenzimidazole; the antioxidant is at least one of N-(1-methylisoamyl)-N′-phenyl-p-phenylenediamine and p-phenylaniline or dilauryl sulfide dipropionate; the activator is at least one of zinc gluconate, zinc oxide and magnesium oxide; the softener is at least one of stearic acid, dibutyl titanate and dioctyl adipate; and the reinforcing filler is at least one of carbon black N110, N220, N330, N339, N375, N550, N660 and silica.

8. The preparation process of a GO/NR based on interpenetrating double crosslinked network structure constructed by dual vulcanizing agents according to claim 1, wherein in step 2, a mass ratio of the NR to the rubber assistant in the GO/NR masterbatch is 100:8-15.

9. The preparation process of a GO/NR based on interpenetrating double crosslinked network structure constructed by dual vulcanizing agents according to claim 1, wherein in step 3, T₅=room temperature, the time for placing the mixed rubber t₄=20-30 h; and the vulcanization temperature T₆=140-160 °C, the vulcanization pressure P₁=10-20 MPa, and the vulcanization time t₅=5-15 min.
